(19) United States
(12) Patent Application Publication
(10) Pub. No.: US 2015/0347913 A1
(43) Pub. Date: Dec. 3, 2015

(54) AUTOMATIC DISCOVERY OF COUNTER-INTUTIVE INSIGHTS

(71) Applicants: Paul Pallath, BANGALORE (IN); Indranil Basu, BANGALORE (IN)

(72) Inventors: Paul Pallath, BANGALORE (IN); Indranil Basu, BANGALORE (IN)

(21) Appl. No.: 14/293,252

(22) Filed: Jun. 2, 2014

(51) Int. Cl. G06N 5/04; G06F 17/30

(52) U.S. Cl. CPC G06N 5/047; G06F 17/30595

(57) ABSTRACT

Automatic discovery of counter-intuitive insights in data analytics involves computing a first set of values based on primary values and secondary values. The primary values include outliers. The computed first set of values is identified as a primary pattern. Compute a second set of values based on the primary values and first level secondary sub-values. The computed second set of values is identified as a secondary pattern. The identified secondary pattern is opposite to the identified primary pattern. The identified primary pattern and the secondary pattern are displayed in a graphical user interface.

### BACKGROUND

Data analytics enables automatic discovery of useful information in large enterprise data repositories. Various techniques and methodologies are adopted to find interesting and useful patterns that might otherwise remain unknown. In the process of finding useful patterns, some form of distortion or abnormal data may appear in the form of noise and outliers. Though noise may not have meaningful data, outliers may have some data or patterns of interest, providing useful insights in data analytics.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. Various embodiments, together with their advantages, may be best understood from the following detailed description taken in conjunction with the accompanying drawings.

FIG. 1 is a block diagram illustrating an example environment for automatic discovery of counter-intuitive insights in data analytics, according to one embodiment.

FIG. 2 is a block diagram of a data analytics application illustrating a user interface providing counter-intuitive insights, according to one embodiment.

FIG. 3 illustrates a sample dataset including outliers, according to one embodiment.

FIG. 4 is a block diagram illustrating inclusive hierarchy and exclusive hierarchy in a sample dataset, according to one embodiment.

FIG. 5 illustrates identifying counter-intuitive patterns in a sample dataset including outliers, according to one embodiment.

FIG. 6 illustrates identifying a counter-intuitive pattern in a sample dataset including outliers, according to another embodiment.

FIG. 7 illustrates identifying a counter-intuitive pattern in a sample dataset including outliers, according to another embodiment.

FIG. 8 illustrates identifying a counter-intuitive pattern in a sample dataset including outliers, according to another embodiment.

FIG. 9 is a flow diagram of a process of automatic discovery of counter-intuitive insights in data analytics, according to one embodiment.

FIG. 10 is a block diagram of an exemplary computer system, according to one embodiment.

### DETAILED DESCRIPTION

Embodiments of techniques for automatic discovery of counter-intuitive insights are described herein. In the following description, numerous specific details are set forth to provide a thorough understanding of the embodiments. A person of ordinary skill in the relevant art will recognize, however, that the embodiments can be practiced without one or more of the specific details, or with other methods, components, materials, etc. In some instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

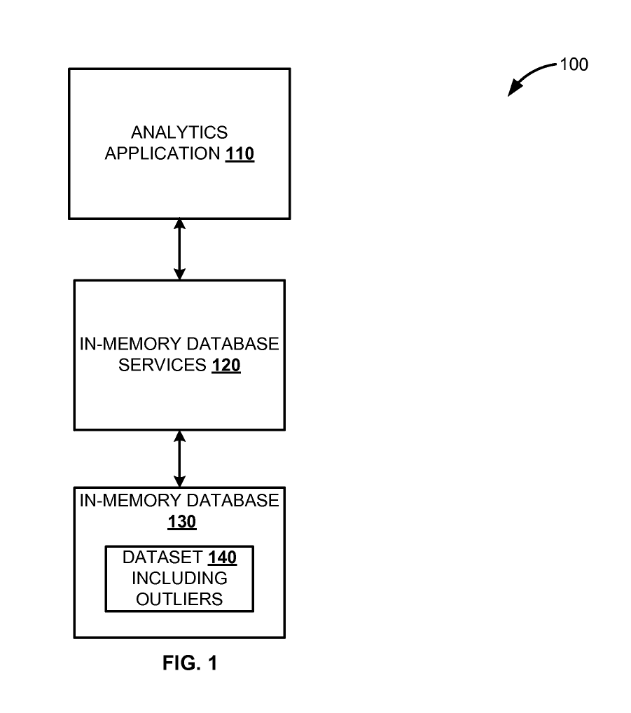

FIG. 1 is a block diagram illustrating example environment 100 for automatic discovery of counter-intuitive insights in data analytics, according to one embodiment. The environment 100 as shown contain analytics application 110, in-memory database services 120 and in-memory database 130. Merely for illustration, only representative number and types of systems are shown in FIG. 1. Other environments may contain more analytics applications and in-memory databases, both in number and type, depending on the purpose for which the environment is designed.

Analytics application 110 sends a request to in-memory database 130 for performing data analytics operations on dataset 140 including outlier data, available in the in-memory database 130. A connection is established from the analytics application 110 to the in-memory database 130 via in-memory database services 120. Connectivity between the analytics application 110 and the in-memory database services 120, and/or the connectivity between the in-memory database services 120 and the in-memory database 130 may be implemented using any standard protocols such as Transmission Control Protocol (TCP) and/or Internet Protocol (IP), etc.

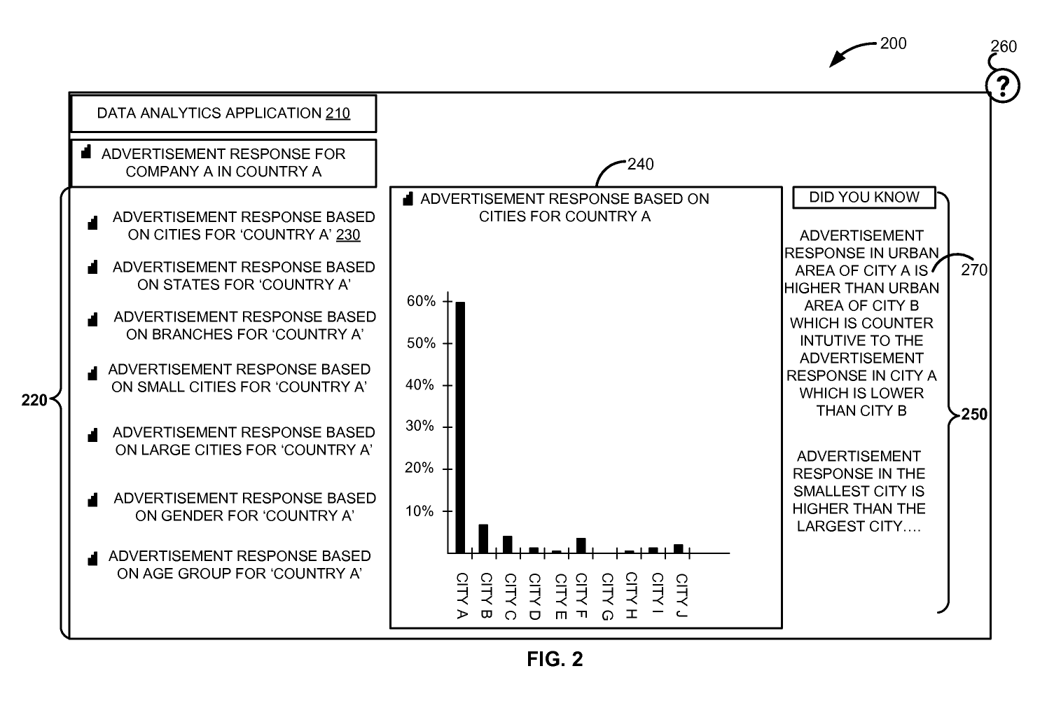

FIG. 2 is a block diagram of a data analytics application illustrating user interface 200 providing counter-intuitive insights, according to one embodiment. For example, in the data analytics application 210, a user performs data analytics operation to understand the advertisement response for a company. When the user issues a query to perform data analytics to understand the advertisement response for the company in ‘country A’, results of the analytics operation are displayed to the user in result window 220. For example, one result of such analytics may be accessed at the result window 220 under ‘advertisement response based on cities for ‘country A’’ 230 link. When the user clicks on ‘advertisement response based on cities for ‘country A’’ 230, a graphical representation of the advertisement response analytics for ‘country A’ may be displayed in graph window 240, where the cities are displayed along x-axis and the response rate are displayed along y-axis of a two-dimensional coordinate system.

Typically, when such data analytics is performed, data that falls within an acceptable reference range are used for analytics, and data that falls outside the acceptable reference range are regarded as outliers and are not used for data analytics. Such outliers may indicate unique or abnormal behavior and can be used to automatically identify patterns that are counter-intuitive. A pattern or behavior of data, counter or opposite to what seems intuitively correct is referred to as counter-intuitive. Analytics may be performed on a dataset including such outliers to automatically identify counter-intuitive results, without the user intervention. The identified counter-intuitive results are displayed in the counter-intuitive results window 250. The user can also click on icon 260 to view the counter-intuitive results in the counter-intuitive results portion 250. For example, when the user clicks on icon 260, the counter-intuitive results corresponding to the analytics performed to understand the advertisement response for the company in the ‘country A’ is displayed in the counter-intuitive results portion 250. When user clicks on one such counter-intuitive result 270, corresponding data or graphical representation of the counter-intuitive result 270 can be displayed in a new window for further analysis.

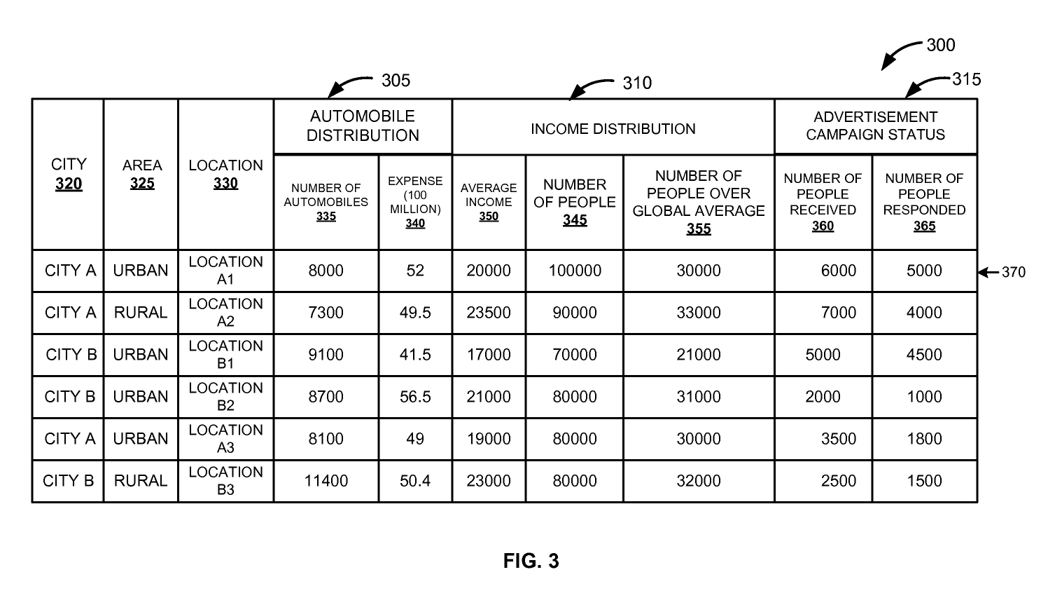

FIG. 3 illustrates sample dataset 300 including outliers, according to one embodiment. Qualitative values or descriptive values are referred to as dimensions, and quantitative values are referred to as measures. Data associated with business use cases such as ‘automobile distribution’ 305, ‘income distribution’ 310 and ‘advertisement campaign status’ 315 are analyzed against dimensions such as city 320, area 325 and location 330, for identifying counter-intuitiveness. These dimensions city 320, area 325 and location 330 against which analysis is performed are referred to as secondary attributes. In the business use case ‘automobile distribution’ 305, dimension such as number of automobiles 335 and measure such as expense (100 million) 340 are considered. Similarly, in the business use case ‘income distribution’ 310, dimension such as number of people 345, and measures such as average income 350 and number of people over global average income 355 are considered. Similarly, in the business use case ‘advertisement campaign status’ 315, dimensions such as number of people received 360 and number of people responded 365 are considered. The dimensions and measures associated with the business use cases are referred to as primary attributes. Analytics is performed on values associated with these primary attributes and the secondary attributes to automatically identify counter-intuitive patterns in the sample dataset 300.

In the sample dataset 300, for each dimension city, area and location, values for the business use cases such as ‘automobile distribution’ 305, ‘income distribution’ 310 and ‘advertisement campaign status’ 315 are computed. For example, the values ‘city A’, ‘urban’ and ‘location A1’ associated with secondary attributes city, area and location are referred to as secondary values. Similarly values computed for the business use case primary attributes such as number of automobiles is ‘8000’, expense is ‘52’, average income is ‘20000’, number of people is ‘100000’, number of people over global average income is ‘30000’, number of people received is ‘6000’ and number of people responded is ‘5000’ are referred to as primary values. These primary values and secondary values are shown in row 370. Similarly, primary values and secondary values are computed for all the other primary attributes and secondary attributes. These primary values include outliers.

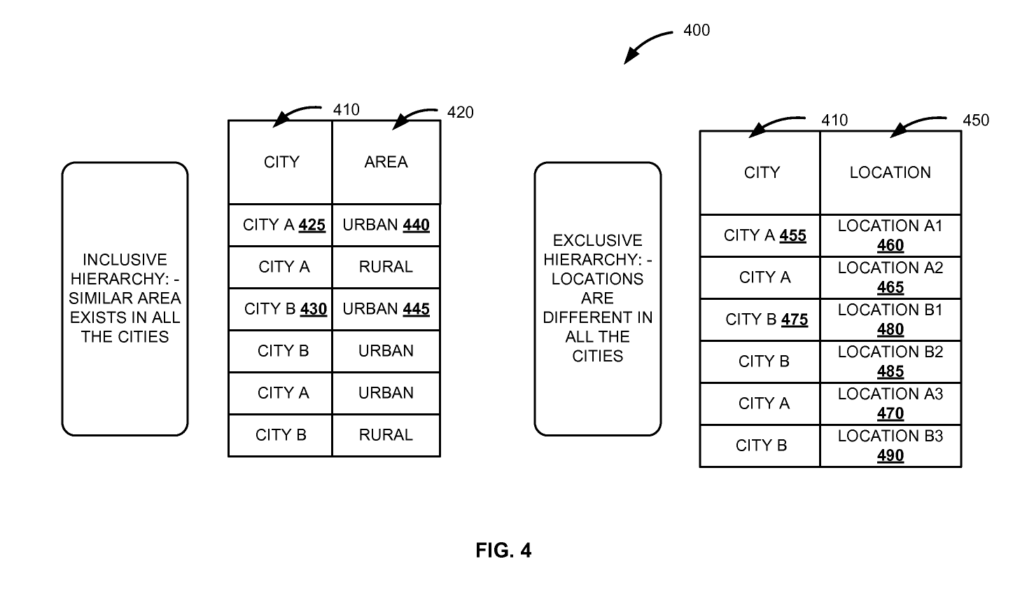

FIG. 4 is block diagram 400 illustrating inclusive hierarchy and exclusive hierarchy in a sample dataset, according to one embodiment. Secondary attributes such as city 410, area 420 and location 450 may be considered for data analytics. City 410, area 420 and location 450 are in a hierarchical relationship, where city 410 is at a higher level or first level in the hierarchy, area 420 is at a second level or lower level in the hierarchy, and location 450 is at a third level or lower level in the hierarchy. Individual values in the dimension city 410 are referred to as values, and the individual values in the dimension area 420 are referred to as sub-values. For example, value ‘city A’ 425 is at a higher level or first level in the hierarchy and the sub-value ‘urban’ 440 is at a lower level or second level in the hierarchy. These values and sub-values are referred to as secondary values and secondary sub-values respectively. In one embodiment, both values ‘city A’ 425 and ‘city B’ 430 have a common area sub-values ‘urban’ 440 and ‘urban’ 445 respectively, and this is referred to as an inclusive hierarchy. An inclusive hierarchy is referred to as a hierarchy where two different values in higher level can have common sub-values in the lower level.

The secondary attributes city 410 and location 450 hold a hierarchical relationship, where city 410 is at a higher level or first level in the hierarchy and location 450 is at a lower level or third level in the hierarchy. For example, value ‘city A’ 455 is at a higher level or first level in the hierarchy and the sub-values ‘location A1’ 460, ‘location A2’ 465 and ‘location A3’ 470 are at a lower level or third level in the hierarchy. Value ‘city B’ 475 is at a higher level or first level in the hierarchy and the sub-value ‘location B1’ 480, ‘location B2’ 485 and ‘location B3’ 490 are at a lower level or third level in the hierarchy. Both values ‘city A’ 455 and ‘city B’ 475 do not have a common location sub-value, and this is referred to as an exclusive hierarchy. An exclusive hierarchy is referred to as a hierarchy where two different values in higher level have no common sub-values in the lower level.

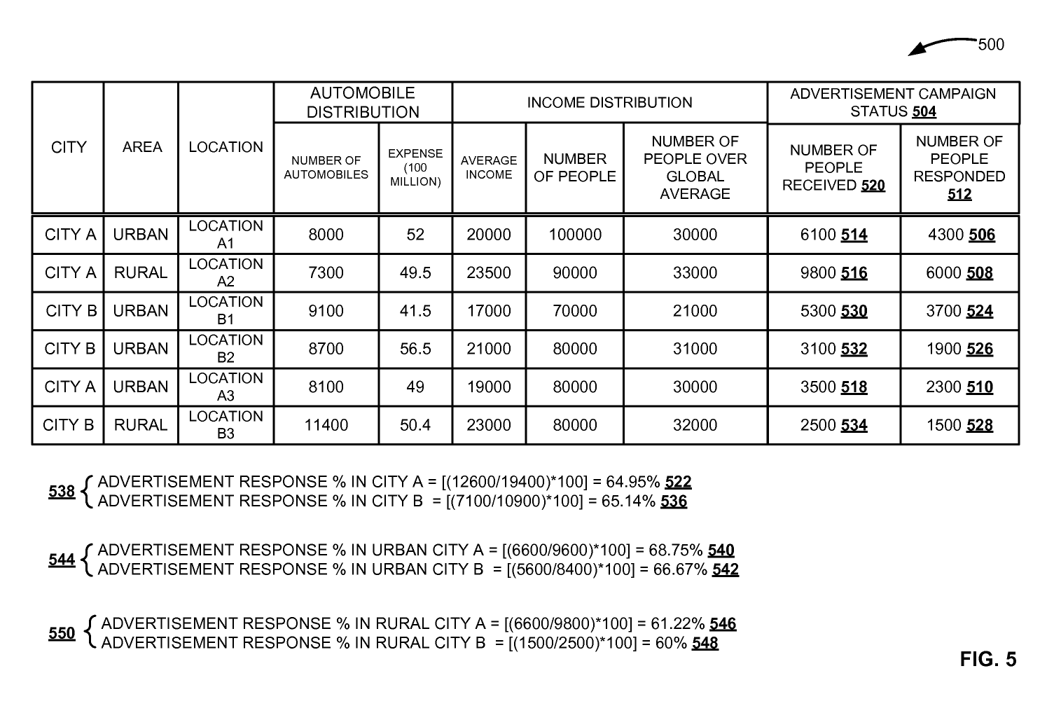

FIG. 5 illustrates identifying counter-intuitive patterns in sample dataset 500 including outliers, according to one embodiment. Sample dataset 500 is generated including outliers. In one embodiment, consider the business use case of ‘advertisement campaign status’ 504. Advertisement response percentage in individual cities is computed and automatically identified as a primary pattern or reference pattern. For example, advertisement response percentage for value ‘city A’ is automatically computed by using the formula [(sum of number of people responded to advertisements in ‘city A’/sum of number of people received advertisements in ‘city A’)*100]. The sum of number of people responded to advertisements in ‘city A’ is automatically computed as 12600 by adding the individual values at 506, 508 and 510 corresponding to ‘city A’ in the dimension ‘number of people responded’ 512. The sum of number of people received advertisements in ‘city A’ is automatically computed as 19400 by adding the individual values at 514,516 and 518 corresponding to ‘city A’ in the dimension ‘number of people received’ 520. Accordingly, the advertisement response percentage in ‘city A’ is computed to a value [(12600/19400)*100]=64.95% as shown in 522.

For example, advertisement response percentage for value ‘city B’ is automatically computed by using the formula [(sum of number of people responded to advertisements in ‘city B’/sum of number of people received advertisements in ‘city B’)*100]. The sum of number of people responded to advertisements in ‘city B’ is automatically computed as 7100 by adding the individual values at 524, 526 and 528 corresponding to ‘city B’ in the dimension ‘number of people responded’ 512. Sum of number of people received advertisements in ‘city B’ is automatically computed as 10900 by adding the individual values at 530, 532 and 534 corresponding to ‘city B’ in the dimension ‘number of people received’ 520. Accordingly, the advertisement response percentage in ‘city B’ is computed to a value [(7100/10900)*100]=65.14% as shown in 536. The values 64.95% and 65.14% computed in 522 and 536 are referred to as a first set of values. The advertisement response percentage in ‘city A’ 64.95% is lesser than the advertisement response percentage in ‘city B’ 65.14%. This is identified as the primary pattern or reference pattern as shown in 538.

For the values ‘city A’ and ‘city B’ inclusive hierarchy elements are identified as sub-values ‘urban’ and ‘rural’, since the sub-values ‘urban’ and ‘rural’ are available in both the values ‘city A’ and ‘city B’. The inclusive hierarchy sub-value ‘urban’ in ‘city A’ is referred to as a first level secondary sub-value. Advertisement response percentage for inclusive hierarchy sub-value ‘urban’ in ‘city A’ is computed using the formula [(sum of number of people responded to advertisements in ‘urban’ ‘city A’/sum of number of people received advertisements in ‘urban’ ‘city A’)*100]. The sum of number of people responded to advertisements in ‘urban’ ‘city A’ is automatically computed as 6600 by adding individual values at 506 and 510, since 506 and 510 correspond to ‘urban’ ‘city A’. The sum of number of people received advertisements in ‘urban’ ‘city A’ is automatically computed as 9600 by adding individual values at 514 and 518, since 514 and 518 correspond to ‘urban’ ‘city A’. Accordingly, the advertisement response percentage in ‘urban’ ‘city A’ is computed to a value [(6600/9600)*100]=68.75% as shown in 540.

The inclusive hierarchy sub-value ‘urban’ in ‘city B’ is referred to as a first level secondary sub-value. Similarly, computation is performed for inclusive hierarchy sub-value ‘urban’ in ‘city B’ using the formula [(sum of number of people responded to advertisements in ‘urban’ ‘city B’/sum of number of people received advertisements in ‘urban’ ‘city B’)*100]. The sum of number of people responded to advertisements in ‘urban’ ‘city B’ is automatically computed as 5600 by adding individual values at 524 and 526, since 524 and 526 correspond to ‘urban’ ‘city B’. Sum of number of people received advertisements in ‘urban’ ‘city B’ is automatically computed as 8400 by adding individual values at 530 and 532, since 530 and 532 correspond to ‘urban’ ‘city B’. Accordingly, the advertisement response percentage in ‘urban’ ‘city B’ is computed to a value [(5600/8400)*100]=66.67% as shown in 542. The computed values 68.75% and 66.67% in 540 and 542 are referred to as a second set of values.

The advertisement response percentage in ‘urban’ ‘city A’ 68.75% is higher than the advertisement response percentage in ‘urban’ ‘city B’ 66.67%. In the primary pattern, the advertisement response percentage in ‘city A’ 64.95% is lesser than the advertisement response percentage in ‘city B’ 65.14%, whereas, the advertisement response percentage in ‘urban’ ‘city A’ 68.75% is higher than the advertisement response percentage in ‘urban’ ‘city B’ 66.67%. This opposite or counter behavior of computed values is automatically identified as a counter-intuitive pattern or secondary pattern as shown in 544. The identified counter-intuitive pattern or secondary pattern 544 is opposite to the identified primary pattern or reference pattern 538.

As another example, the inclusive hierarchy sub-value ‘rural’ in ‘city A’ is referred to as a first level secondary sub-value. Advertisement response percentage for inclusive hierarchy sub-value ‘rural’ in ‘city A’ is computed using the formula [(sum of number of people responded to advertisements in ‘rural’ ‘city A’/sum of number of people received advertisements in ‘rural’ ‘city A’)*100]. The sum of number of people responded to advertisements in ‘rural’ ‘city A’ is automatically computed as 6000 since only one element at 508 corresponds to ‘rural’ ‘city A’. The sum of number of people received advertisements in ‘rural’ ‘city A’ is 9800 since only one element at 516 corresponds to ‘rural’ ‘city A’. Accordingly, the advertisement response percentage in ‘rural’ ‘city A’ is computed to a value [(6000/9800)*100]=61.22% as shown in 546.

The inclusive hierarchy sub-value ‘rural’ in ‘city B’ is referred to as a first level secondary sub-value. Similar computation is performed for the inclusive hierarchy ‘rural’ in ‘city B’ using the formula [(sum of number of people responded to advertisements in ‘rural’ ‘city B’/sum of number of people received advertisements in ‘rural’ ‘city B’)*100]. The sum of number of people responded to advertisements in ‘rural’ ‘city B’ is 1500 since only one element at 528 corresponds to ‘rural’ ‘city B’. The sum of number of people received advertisements in ‘rural’ ‘city B’ is 2500 since only one element at 534 corresponds to ‘rural’ ‘city B’. Accordingly, the advertisement response percentage in ‘rural’ ‘city B’ is automatically computed to a value [(1500/2500)*100]=60% as shown in 548. The computed values 61.22% and 60% in 546 and 548 are referred to as a second set of values. The advertisement response percentage in ‘rural’ ‘city A’ 61.22% is higher than the advertisement response percentage in ‘rural’ ‘city B’ 60%.

In the primary pattern the advertisement response percentage in ‘city A’ is lesser than the advertisement response percentage in ‘city B’, whereas, the advertisement response percentage in ‘rural’ ‘city A’ 61.22% is higher than the advertisement response percentage in ‘rural’ ‘city B’ 60%. This opposite or counter behavior of computed data is automatically identified as a counter-intuitive pattern or secondary pattern as shown in 550. The identified counter-intuitive pattern or secondary pattern 550 is opposite to the identified primary pattern or reference pattern 538. In the above example, counter-intuitive patterns or secondary patterns 544 and 550 were identified for both the cases of inclusive hierarchical sub-values ‘urban’ and ‘rural’. Accordingly, it can be referred to as a strong counter-intuitive behavior. Such strong counter-intuitive behavior is a rare occurrence in the sample dataset. If the counter-intuitive pattern was not identified for either of the pattern 544 or 550, it can be referred to as a weak counter-intuitive behavior. Such weak counter-intuitive behavior is not a rare occurrence in the sample dataset.

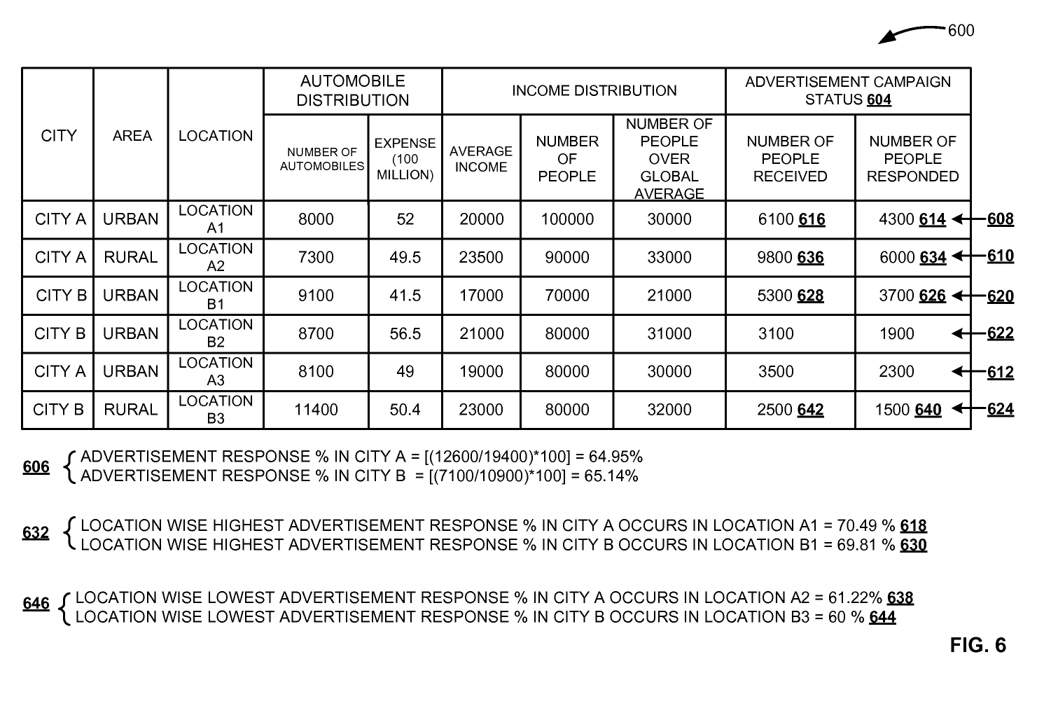

FIG. 6 illustrates identifying counter-intuitive patterns in a sample dataset 600 including outliers, according to another embodiment. Sample dataset 600 is generated including outliers. In one embodiment, consider the business use case of ‘advertisement campaign status’ 604. Advertisement response percentage in individual cities is computed and identified as a primary pattern or reference pattern 606 as explained above with reference to 538 in FIG. 5. For example, location wise highest advertisement response percentage in ‘city A’ is computed. Highest advertisement response is referred to as maximum value for the primary value, and location in a city is referred to as a second level secondary sub-value. Consider ‘city A’ with three locations ‘location A1’, ‘location A2’ and ‘location A3’ in the three rows 608, 610 and 612 respectively. The advertisement response percentage for all the locations in ‘city A’, is computed using the formula [(number responded in ‘location’ ‘city A’/number received in ‘location’ ‘city A’)*100], and the location with highest response percentage is considered. The considered sub-value ‘location A1’ in ‘city A’ is referred to as a second level secondary sub-value. The number responded in ‘location A1’ ‘city A’ is 4300 as shown in 614, and the number received in ‘location A1’ ‘city A’ is 6100 as shown in 616. Accordingly, advertisement response percentage for ‘location A1’ in ‘city A’ is computed to a value [(4300/6100)*100]=70.49% as shown in 618. Location wise highest advertisement response percentage in ‘location A2’ in ‘city A’ is 70.49%.

Similarly, the location wise highest advertisement response in ‘city B’ is computed. Consider ‘city B’ with three locations ‘location B1’, ‘location B2’ and ‘location B3’ in three rows 620, 622 and 624 respectively. The advertisement response percentage for all the locations in ‘city B’ is computed using the formula [(number responded in ‘location’ ‘city B’/number received in ‘location’ ‘city B’)*100], and the location with lowest response percentage is considered. The considered sub-value ‘location B1’ in ‘city B’ is referred to as a second level secondary sub-value. The number responded in ‘location B1’ ‘city B’ is 3700 as shown in 626, and the number received in ‘location B1’ ‘city B’ is 5300 as shown in 628. Accordingly, advertisement response percentage for ‘location B1’ in ‘city B’ is computed to a value [(3700/5300)*100]=69.81% as shown in 630. Location wise highest advertisement response percentage in ‘location B1’ in ‘city B’ is 69.81%. The computed values 70.49% and 69.81% in 618 and 630 are referred to as a third set of values.

In the primary pattern or reference pattern 606, the advertisement response percentage in ‘city A’ is lesser than the advertisement response percentage in ‘city B’, whereas, location wise highest advertisement response percentage in ‘location A1’ in ‘city A’ is (70.49%) higher than in ‘city B’ (69.81%). This opposite or counter behavior of computed values is automatically identified as a counter-intuitive pattern or secondary pattern as shown in 632. The identified counter-intuitive pattern or secondary pattern 632 is opposite to the identified primary pattern or reference pattern 606.

As another example, the location wise lowest advertisement response in ‘city A’ is computed. Consider ‘city A’ with three locations ‘location A1’, ‘location A2’ and ‘location A3’ in three rows 608, 610 and 612 respectively. Lowest advertisement response is referred to as a minimum value for the primary value, and location in a city is referred to as a second level secondary sub-value. The advertisement response percentage for all the locations in ‘city A’ is computed using the formula [(number responded in the ‘location’ ‘city A’/number received in ‘location’ ‘city A’)*100], and the location with lowest response percentage is considered. The considered sub-value ‘location A2’ in ‘city A’ is referred to as the second level secondary sub-value. The number responded in ‘location A2’ ‘city A’ is 6000 as shown in 634. The number received in ‘location A2’ ‘city A’ is 9800 as shown in 636. Accordingly, advertisement response percentage for ‘location A2’ in ‘city A’ is computed to a value [(6000/9800)*100]=61.22% as shown in 638. Location wise lowest advertisement response percentage in ‘location A2’ in ‘city A’ is 61.22%.

Similarly, the location wise lowest advertisement response in ‘city B’ is computed. Consider ‘city B’ with three locations ‘location B1’, ‘location B2’ and ‘location B3’ in three rows 620, 622 and 624 respectively. The advertisement response percentage for all the locations in ‘city B’ is computed using the formula [(number responded in ‘location’ ‘city B’/number received in ‘location’ ‘city B’)*100], and the location with lowest response percentage is considered. The considered sub-value ‘location B3’ in ‘city B’ is referred to as a second level secondary sub-value. The number responded in ‘location B3’ ‘city B’ is 1500 as shown in 640, and the number received in ‘location B3’ ‘city B’ is 2500 as shown in 642. Accordingly, advertisement response percentage for ‘location B3’ in ‘city B’ is computed to a value [(1500/2500)*100]=60% as shown in 644. Location wise lowest advertisement response percentage in ‘location B3’ in ‘city B’ is 60%. The values 61.22% and 60% computed in 638 and 644 are referred to as a fourth set of values.

In the primary pattern, the advertisement response percentage in ‘city A’ is lesser than the advertisement response percentage in ‘city B’, whereas, location wise lowest advertisement response percentage in ‘location A2’ in ‘city A’ is (61.22%) higher than the location wise lowest advertisement response percentage in ‘location B3’ in ‘city B’ (60%). This opposite or counter behavior of computed values is automatically identified as a counter-intuitive pattern or secondary pattern as shown in 646. The identified counter-intuitive pattern or secondary pattern 646 is opposite to the identified primary pattern or reference pattern 606.

In the above example, counter-intuitive patterns or secondary patterns were identified for both the cases of location wise highest advertisement response percentage and location wise lowest advertisement response percentage. Accordingly, it can be referred to as a strong counter-intuitive behavior. Such strong counter-intuitive behavior is a rare occurrence in the sample dataset 600. If, for either the location wise highest advertisement response percentage or the location wise lowest advertisement response percentage, a counter-intuitive or secondary pattern was not identified, it can be referred to as a weak counter-intuitive behavior. Such weak counter-intuitive behavior is not a rare occurrence in the sample dataset 600.

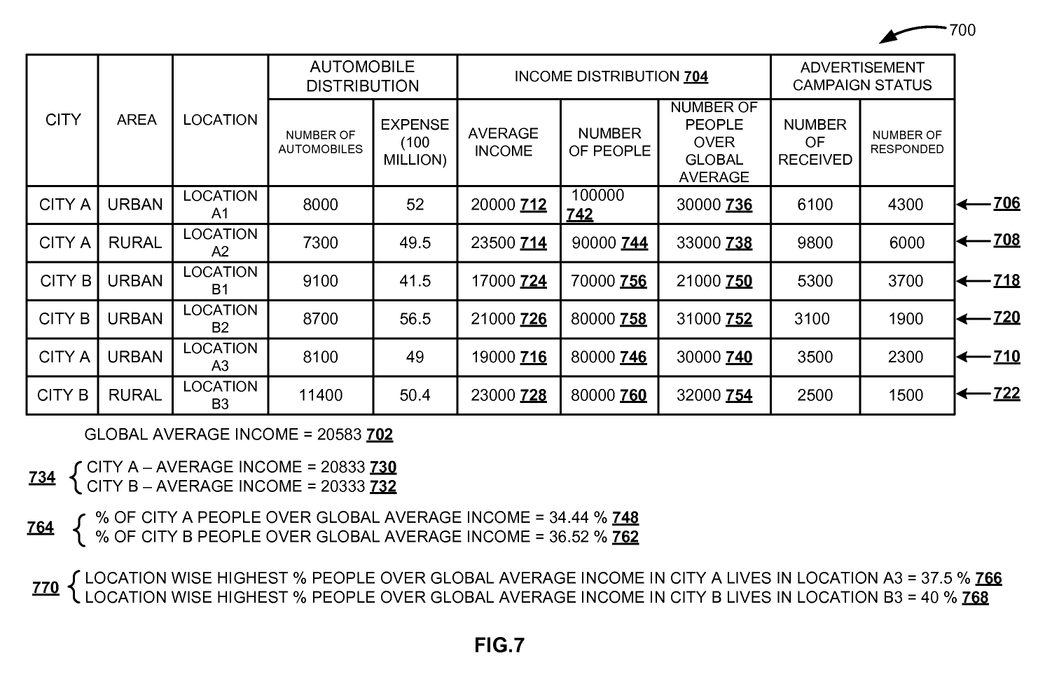

FIG. 7 illustrates identifying counter-intuitive patterns in sample dataset 700 including outliers, according to another embodiment. In one embodiment, consider the business use case of ‘income distribution’ 704. Global average income is computed to a value 20583 as shown in 702, by adding individual values in 712, 714, 724, 726, 716 and 728 and dividing by ‘6’ since there are 6 locations. Average income in individual cities is computed and automatically identified as a primary pattern or reference pattern. Consider ‘city A’ with three locations ‘location A1’, ‘location A2’ and ‘location A3’ in three rows 706, 708 and 710 respectively. For example, average income for value ‘city A’ is computed by using the formula [sum of average income of people in various locations ‘city A’/number of locations in ‘city A’]. The sum of average income of people in various locations in ‘city A’ is computed as 62500 by adding values at 712, 714 and 716. Since there are three locations ‘location A1’, ‘location A2’ and ‘location A3’, number of locations in ‘city A’ is computed as 3. Accordingly, the average income of people in ‘city A’ is computed to a value [62500/3]=20833 as shown in 730.

Similarly, average income of people in ‘city B’ is computed. Consider ‘city B’ with three locations ‘location B1’, ‘location B2’ and ‘location B3’ occurring in three rows 718, 720 and 722 respectively. For example, average income for value ‘city B’ is computed by using the formula [sum of average income of people in various locations ‘city B’/number of locations ‘location B1’, ‘location B2’ and ‘location B3’ in ‘city B’]. The sum of average income of people in various locations in ‘city B’ is computed as 61000 by adding values at 724, 726 and 728. Since there are three locations ‘location B1’, ‘location B2’ and ‘location B3’, the number of locations in ‘city B’ is 3. Accordingly, the average income of people in ‘city B’ is computed to a value [61000/3]=20333 as shown in 732. The average income of people in ‘city A’ is 20833, which is higher than the average income of people in ‘city B’ 20333. This is automatically identified as a primary pattern or reference pattern as shown in 734.

Percentage of people over a global average income is computed for individual cities. For example, the percentage of people in ‘city A’ over the global average income distribution is computed. Consider ‘city A’ with three locations ‘location A1’, ‘location A2’ and ‘location A3’ in three rows 706, 708 and 710 respectively. Percentage of people over a global average income in ‘city A’ is computed using the formula [(sum of number of people over global average income in ‘city A’/Total number of people in ‘city A’)*100]. The sum of number of people over global average income in ‘city A’ is computed as 93000 by adding the individual values at 736, 738 and 740. Total number of people in ‘city A’ is computed as 270000 by adding individual values at 742, 744 and 746. Percentage of people in ‘city A’ over the global average income is computed to a value [(93000/270000)*100]=34.44% as shown in 748.

Similarly, the percentage of people in ‘city B’ over the global average income is computed. Consider ‘city B’ with three locations ‘location B1’, ‘location B2’ and ‘location B3’ in three rows 718, 720 and 722 respectively. Percentage of people over a global average income in ‘city B’ is computed using the formula [(sum of number of people over global average income in ‘city B’/Total number of people in ‘city B’)*100]. The sum of number of people over global average income in ‘city B’ is computed as 84000 by adding individual values at 750, 752 and 754. Total number of people in ‘city B’ is computed as 230000 by adding individual values at 756, 758 and 760. Percentage of people in ‘city B’ over the global average income is computed to a value [(84000/230000)*100]=36.52% as shown in 762. In the identified primary pattern or reference pattern, average income of people in ‘city A’ is more than the average income of people in ‘city B’, however, the percentage of people in ‘city A’ over the global average income (32.59%) is lesser than the percentage of people in ‘city B’ over the global average income (36.52%). This opposite or counter behavior of computed values is automatically identified as a counter-intuitive pattern or secondary pattern as shown in 764. The identified counter-intuitive pattern or secondary pattern 764 is opposite to the identified primary pattern or reference pattern 734.

As another example, the location wise highest percentage of people over global average income in ‘city A’ is computed. Consider ‘city A’ with three locations ‘location A1’, ‘location A2’ and ‘location A3’ in three rows 706, 708 and 710 respectively. The sub-value ‘location A3’ in ‘city A’ is referred to as a second level secondary sub-value. The location wise highest percentage people over global average income in ‘location A3’ in ‘city A’ is computed using the formula [(number of people over global average income in ‘location A3’ ‘city A’/number of people in ‘location A3’ ‘city A’)*100]. The number of people over global average income in ‘location A3’ ‘city A’ is 30000 as shown in 740, and the number of people in ‘locationA3’ ‘city A’ is 80000 as shown in 746. Accordingly, percentage of people over global average income for ‘location A3’ in ‘city A’ is computed to a value [(30000/80000)*100]=37.5% as shown in 766. Location wise highest percentage people over global average income in ‘location A3’ in ‘city A’ is 37.5%.

Similarly, consider ‘city B’ with three locations ‘location B1’, ‘location B2’ and ‘location B3’ in three rows 718, 720 and 722 respectively. The sub-value ‘location 3’ in ‘city B’ is referred to as a second level secondary sub-value. The location wise highest percentage people over global average income in ‘location B3’ in ‘city B’ is computed using the formula [(number of people over global average income in ‘location B3’ ‘city B’/number of people in ‘location B3’ ‘city B’)*100]. The number of people over global average income in ‘location B3’ ‘city B’ is 32000 as shown in 754 and the number of people in ‘location B3’ ‘city B’ is 80000 as shown in 760. Accordingly, percentage of people over global average income for ‘location B3’ in ‘city B’ is computed to a value of [(32000/80000)*100]=40% as shown in 768. Location wise highest percentage people over global average income in ‘location B3’ in ‘city B’ is 40%. In the identified primary pattern or reference pattern, the average income of people in ‘city A’ is higher than the average income of people in ‘city B’, however, location wise highest percentage people over global average income in ‘location A3’ in ‘city A’ is lesser than in ‘city B’. This pattern is automatically identified as counter-intuitive or secondary pattern as shown in 770. The identified counter-intuitive pattern or secondary pattern 770 is opposite to the identified primary pattern or reference pattern 734.

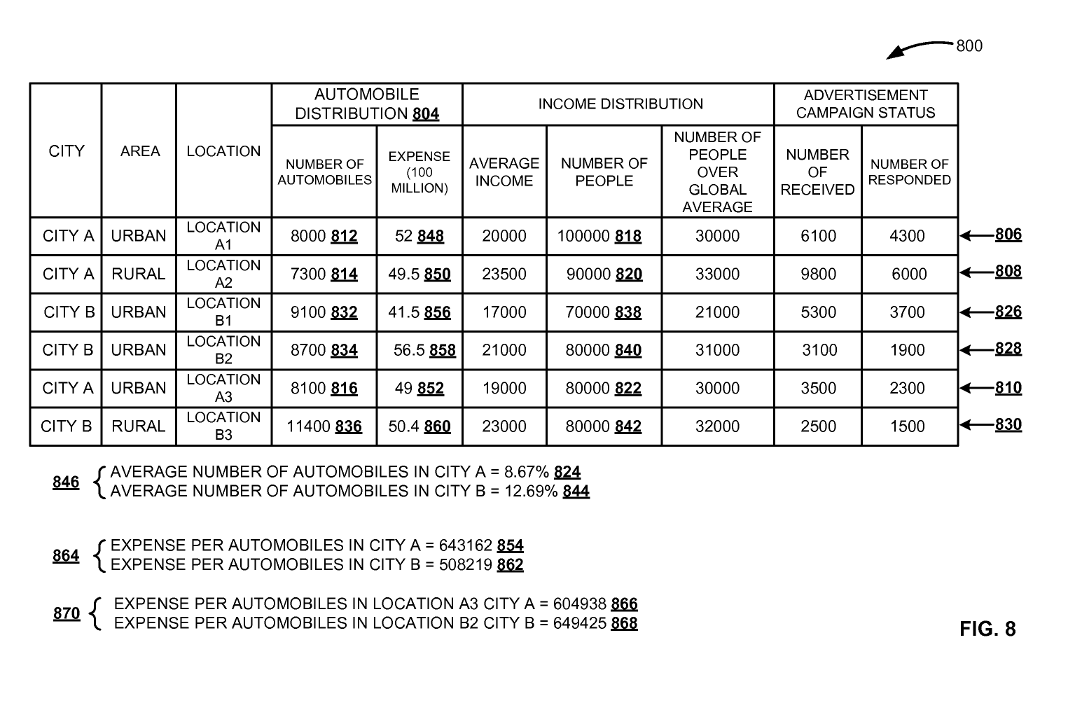

FIG. 8 illustrates identifying counter-intuitive patterns in sample dataset 800 including outliers, according to another embodiment. In one embodiment, consider the business use case of ‘automobile distribution’ 804. Average number of automobiles in individual cities is computed and automatically identified as primary pattern or reference pattern. Consider ‘city A’ with three locations ‘location A1’, ‘location A2’ and ‘location A3’ in three rows 806, 808 and 810 respectively. The average number of automobiles in ‘city A’ is computed using the formula [(number of automobiles in the three locations in ‘city A’/total number of people in three locations in ‘city A’)*100]. The number of automobiles in the three locations in ‘city A’ is computed as 23400 by adding individual values at 812, 814 and 816. The total number of people in three locations in ‘city A’ is computed as 270000 by adding values at 818, 820 and 822. Accordingly, average number of automobiles in ‘city A’ is computed to a value [(23400/270000)*100]=8.67% as shown in 824.

Consider ‘city B’ with three locations ‘location B1’, ‘location B2’ and ‘location B3’ in three rows 826, 828 and 830 respectively. Similarly, the average number of automobiles in ‘city B’ is computed using the formula [(number of automobiles in the three locations in ‘city B’/total number of people in three locations in ‘city B’)*100]. The number of automobiles in the three locations in ‘city B’ is computed as 29200 by adding individual values at 832, 834 and 836. The total number of people in three locations in ‘city B’ is computed as 230000 by adding individual values at 838, 840 and 842. Average number of automobiles in ‘city B’ is computed to a value [(29200/230000)*100]=12.69% as shown in 844. Average number of automobiles in ‘city A’ (8.67%) is less than the average number of automobiles in ‘city B’ (12.69%). This is automatically identified as a primary pattern or reference pattern 846.

As an example, expense per automobile in individual cities is computed. Expense per automobile in ‘city A’ is computed using the formula [sum of expenses per automobile in various locations in ‘city A’/total number of automobiles in ‘city A’]. The sum of expense per automobile in various locations in ‘city A’ is computed as 150 (100 million) by adding individual values at 848, 850 and 852. The total number of automobiles in ‘city A’ is computed as 23400 by adding individual values at 812, 814 and 816. Expense per automobile in ‘city A’ is computed to a values [150*100 million/23400]=643162 as shown in 854.

Similarly, expense per automobile in ‘city B’ is computed using the formula [sum of expense per automobile in various locations in ‘city B’/total number of automobiles in ‘city B’]. The sum of expense per automobile in various locations in ‘city B’ is computed as 148 (100 million) by adding individual values at 856, 858 and 860. The total number of automobiles in ‘city B’ is computed as 29200 by adding individual values at 832, 834 and 836. Expense per automobile in ‘city B’ is computed to a value [148*100 million/29200]=508219 as shown in 862. In the primary pattern or reference pattern, the average number of automobiles in ‘city A’ is lesser than the average number of automobiles in ‘city B’, whereas, the expense per automobile in ‘city A’ (643162) is higher than expense per automobile in ‘city B’ (508219), and this is automatically identified as a counter-intuitive pattern 864 opposite to the identified primary pattern or reference pattern 846.

In one embodiment, consider a scenario where the automatically identified counter-intuitive pattern 864 is taken as a primary pattern or reference pattern. For example to compute expense per automobile in a location in a city. Consider ‘city A’ with three locations ‘location A1’, ‘location A2’ and ‘location A3’ in three rows 806, 808 and 810 respectively. Consider ‘location A3’ in ‘city A’ and compute the expense per automobile in ‘location A3’ in ‘city A’. Expense per automobile in ‘location A3’ is computed using the formula [expense of automobiles in ‘location A3’ in ‘city A’/number of automobiles in ‘location A3’ in ‘city A’]. The expense of automobile in ‘location A3’ in ‘city A’ is 49 (100 million) as shown in 852, and the number of automobiles in ‘location A3’ in ‘city A’ is 8100 as shown in 816. Accordingly, the expense per automobile in ‘location A3’ in ‘city A’ is computed to a value [49*100 million/8100]=604938 as shown in 866.

Similarly, consider ‘location B2’ in ‘city B’ and compute the expense per automobile in ‘location B2’ in ‘city B’. Expense per automobile in ‘location B2’ is computed using the formula [expense of automobiles in ‘location B2’ in ‘city B’/number of automobiles in ‘location B2’ in ‘city B’]. Expense of automobile in ‘location B2’ in ‘city B’ is 56 (100 million) as shown in 858, and the number of automobiles in ‘location B2’ in ‘city B’ is 8700 as shown in 834. The expense per automobile in ‘location B2’ in ‘city B’ is computed as [56*100 million/8700]=649425 as shown in 868. The values 604938 and 649425 are referred to as a fifth set of values. In the primary pattern or reference pattern, expense per automobile in ‘city A’ is higher than expense per automobile in ‘city B’ as shown 864, whereas, the expense per automobile in ‘location A3’ in ‘city A’ is lesser than the expense per automobile in ‘location B2’ in ‘city B’. This is automatically identified as a counter-intuitive pattern 870, opposite to the reference pattern 864.

The above illustrations of primary and secondary patterns are merely exemplary, any number of primary and secondary patterns can be generated depending on the sample dataset and computation techniques used. Though, secondary sub-values are illustrated for two levels in various embodiments, secondary values and secondary sub-values can be in any number of levels. In various embodiments, the identified reference pattern or primary pattern and the identified counter-intuitive pattern or secondary pattern can be displayed in a user interface associated with the data analytics application 210 in FIG. 2. The displayed reference pattern or primary pattern and the counter-intuitive pattern or secondary pattern can be clicked or selected to further display a graphical representation of the selected pattern or patterns in a new window or graphical tool associated with the data analytics application 210 in FIG. 2.

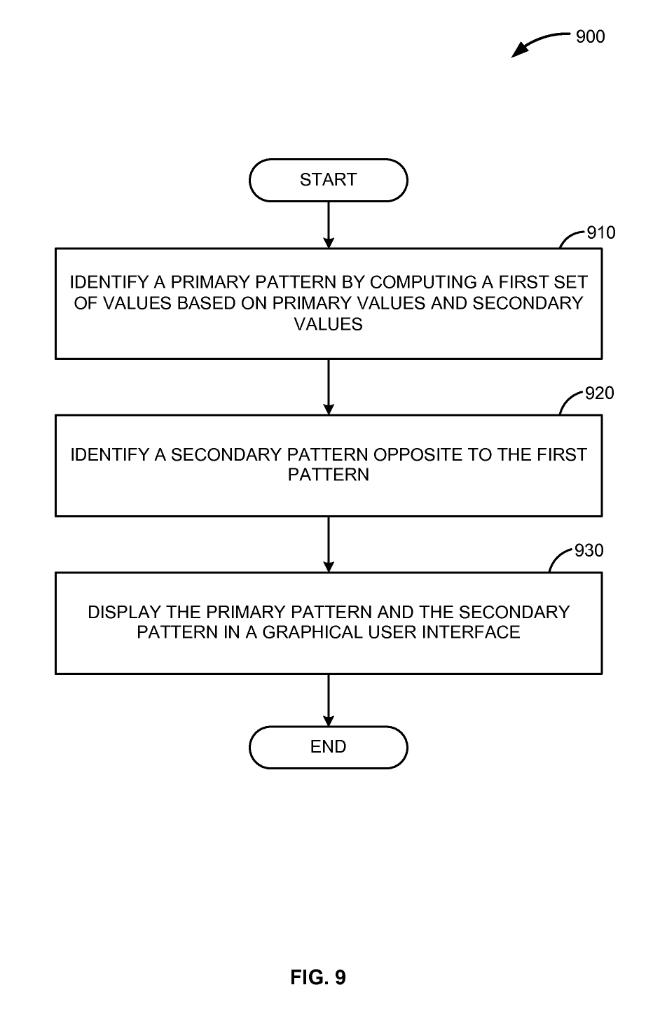

FIG. 9 is a flow diagram of process 900 of automatic discovery of counter-intuitive insights in data analytics, according to one embodiment. At 910, identify a primary pattern by computing a first set of values based on primary values and secondary values. The primary values include outliers. At 920, identify a secondary pattern opposite to the first pattern. The secondary pattern is identified by computing a second set of values based on the primary values and a first level secondary sub-values. At 930, the primary pattern and the secondary pattern are displayed in a graphical user interface.

The various embodiments described above have a number of advantages. The automatic discovery of counter-intuitive insights provides users with counter-intuitive data which otherwise would have remained unidentified. Users can capitalize on the counter-intuitive data identified and focus user's work on the areas requiring attention. Thus users are able to channelize the effort and expenditure based on the identified counter-intuitive facts, thereby, gaining efficiency.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (ASICs), programmable logic devices (PLDs) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

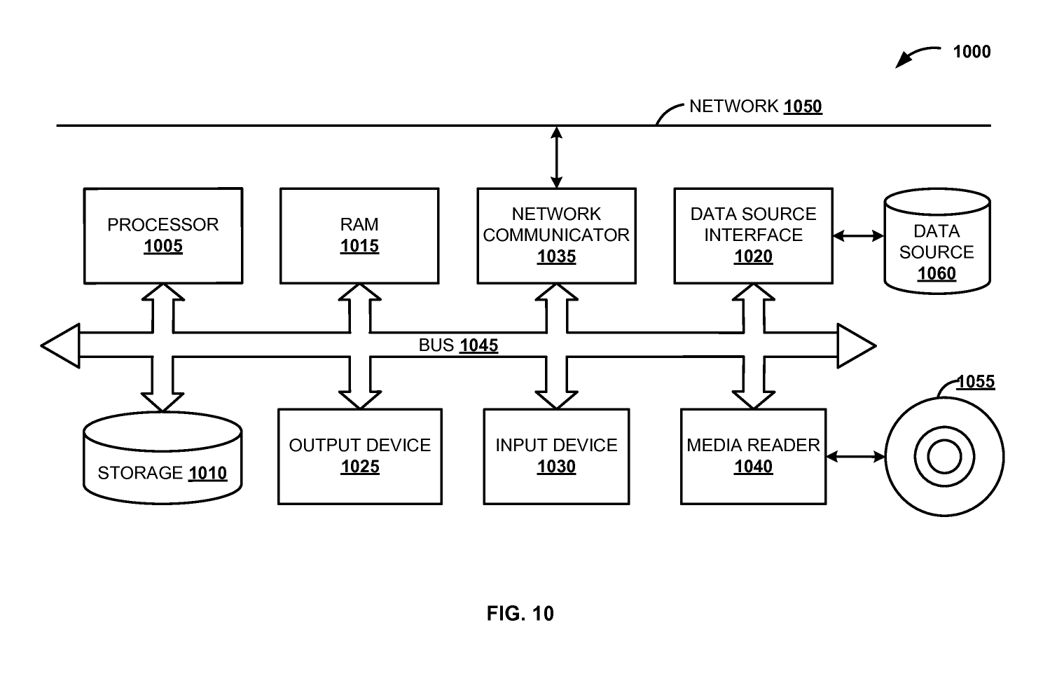

FIG. 10 is a block diagram of an exemplary computer system 1000. The computer system 1000 includes a processor 1005 that executes software instructions or code stored on a computer readable storage medium 1055 to perform the above-illustrated methods. The computer system 1000 includes a media reader 1040 to read the instructions from the computer readable storage medium 1055 and store the instructions in storage 1010 or in random access memory (RAM) 1015. The storage 1010 provides a large space for keeping static data where at least some instructions could be stored for later execution. The stored instructions may be further compiled to generate other representations of the instructions and dynamically stored in the RAM 1015. The processor 1005 reads instructions from the RAM 1015 and performs actions as instructed. According to one embodiment, the computer system 1000 further includes an output device 1025 (e.g., a display) to provide at least some of the results of the execution as output including, but not limited to, visual information to users and an input device 1030 to provide a user or another device with means for entering data and/or otherwise interact with the computer system 1000. Each of these output devices 1025 and input devices 1030 could be joined by one or more additional peripherals to further expand the capabilities of the computer system 1000. A network communicator 1035 may be provided to connect the computer system 1000 to a network 1050 and in turn to other devices connected to the network 1050 including other clients, servers, data stores, and interfaces, for instance. The modules of the computer system 1000 are interconnected via a bus 1045. Computer system 1000 includes a data source interface 1020 to access data source 1060. The data source 1060 can be accessed via one or more abstraction layers implemented in hardware or software. For example, the data source 1060 may be accessed by network 1050. In some embodiments the data source 1060 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A non-transitory computer-readable medium to store instructions, which when executed by a computer, cause the computer to perform operations comprising:
identify a primary pattern by computing a first set of values based on primary values and secondary values, wherein the primary values include outliers;
identify a secondary pattern opposite to the first pattern, wherein the secondary pattern is identified by computing a second set of values based on the primary values and a first level secondary sub-values; and
display the primary pattern and the secondary pattern in a graphical user interface.

2. The computer-readable medium of claim 1, wherein the secondary pattern is identified by computing a third set of values based on a determined maximum value for the primary values and on a second level secondary sub-values.

3. The computer-readable medium of claim 1, wherein the secondary pattern is identified by computing a fourth set of values based on a determined minimum value for the primary values and on a second level secondary sub-values.

4. The computer-readable medium of claim 1, wherein the secondary pattern is identified by computing a fifth set of values based on the primary values and on a second level secondary sub-values.

5. The computer-readable medium of claim 2, wherein the second level secondary sub-values are inclusive corresponding to the first level secondary sub-values.

6. The computer-readable medium of claim 2, wherein the second level secondary sub-values are exclusive corresponding to the first level secondary sub-values.

7. The computer-readable medium of claim 1, wherein based on selection of the secondary pattern, display a graphical representation associated with the secondary pattern in the graphical user interface.

8. A computer-implemented method of automatic discovery of counter-intuitive insights, the method comprising:
identifying a primary pattern by computing a first set of values based on primary values and secondary values, wherein the primary values include outliers;
identifying a secondary pattern opposite to the first pattern, wherein the secondary pattern is identified by computing a second set of values based on the primary values and a first level secondary sub-values; and
displaying the primary pattern and the secondary pattern in a graphical user interface.

9. The method of claim 8, wherein the secondary pattern is identified by computing a third set of value based on a determined maximum value for the primary values and a second level secondary sub-values.

10. The method of claim 8, wherein the secondary pattern is identified by computing a fourth set of value based on a determined minimum value of the primary values and a second level secondary sub-values.

11. The method of claim 8, wherein the secondary pattern is identified by computing a fifth set of value based on the primary values and a second level secondary sub-values.

12. The method of claim 9, wherein the second level secondary sub-values are inclusive corresponding to the first level secondary sub-values.

13. The method of claim 9, wherein the second level secondary sub-values are exclusive corresponding to the first level secondary sub-values.

14. The method of claim 8, wherein based on selection of the secondary pattern, display a graphical representation associated with the secondary pattern in the graphical user interface.

15. A computer system for automatic discovery of counter-intuitive insights, comprising:
a computer memory to store program code; and
a processor to execute the program code to:
identify a primary pattern by computing a first set of values based on primary values and secondary values, wherein the primary values include outliers;
identify a secondary pattern opposite to the first pattern, wherein the secondary pattern is identified by computing a second set of values based on the primary values and a first level secondary sub-values; and
display the primary pattern and the secondary pattern in a graphical user interface.

16. The system of claim 15, wherein the secondary pattern is identified by computing a third set of value based on a determined maximum value for the primary values and a second level secondary sub-values.

17. The system of claim 15, wherein the secondary pattern is identified by computing a fourth set of value based on a determined minimum value for the primary values and on a second level secondary sub-values.

18. The system of claim 15, wherein the secondary pattern is identified by computing a fifth set of value based on the primary values and a second level secondary sub-values.

19. The system of claim 16, wherein the second level secondary sub-values are inclusive corresponding to the first level secondary sub-values.

20. The system of claim 16, wherein the second level secondary sub-values are exclusive corresponding to the first level secondary sub-values, and based on selection of the secondary pattern, display a graphical representation associated with the secondary pattern in the graphical user interface.
